(19) United States
(12) Patent Application Publication
(10) Pub. No.: US 2012/0069427 A1
(43) Pub. Date: Mar. 22, 2012

(54) METHOD AND DEVICE FOR ACOUSTO-OPTIC FILTERING WITH LONG OPTICAL AND ACOUSTIC INTERACTION LENGTH

(75) Inventors: Daniel KAPLAN, Paris (FR); Pierre TOURNOIS, CAGNES S/MER (FR)

(73) Assignee: FASTLITE, Paris (FR)

(21) Appl. No.: 12/888,033

(22) Filed: Sep. 22, 2010

(51) Int. Cl. G02F 1/33

(52) U.S. Cl. 359/308

(57) ABSTRACT

A method and a device for acousto-optic filtering with large optic and acoustic interaction length; includes the use of a birefringent acousto-optic crystal whereof the sound wave propagation speed is as low as possible, this acousto-optical crystal including, on one of its faces, a piezoelectric transducer intended to generate a transverse sound wave whereof the energy propagates collinearly to the energy of an incident light wave, all along the path of the incident light wave, in the aforementioned birefringent acousto-optic crystal, knowing that the transverse sound wave and the incident light wave travel a path including multiple reflections on one or the other of the reflective faces of the birefringent acousto-optic crystal perpendicular to the axes of symmetry shared by the acoustic slownesses curve and the curves of the ordinary and extraordinary optical indices of the acousto-optic crystal.

The present invention concerns a method and a device for acousto-optical filtering with long optical and acoustic interaction length.
This method is applicable in particular to devices whereof the configuration is such that the direction of propagation of the energy from the light beam (called light beam direction and characterized by the Poynting vector) is combined with the propagation direction of the energy from the sound beam (called sound beam direction). This condition ensures the greatest possible interaction length between the light and sound waves, which is favorable for the interaction efficiency. Moreover, when these devices are used for a spectral filtering function of the light wave, this condition favors the obtaining of a high spectral resolution.
In general, it is known that the conditions leading to the collinear interactions in a birefringent material were discussed by V. B. Voloshinov in: “Close to collinear acousto-optique interaction in Paratellurite”, Optical Engineering, 31 (1992), p. 2089. It is well known that when the crystal used is highly anisotropic and birefringent, the co-linearity of the sound and light beams does not imply co-linearity of the sound and light waves. French patent FR 9610717 by P. Tournois “Dispositif de contrôle d'impulsions lumineuses par un dispositif programmable acousto-optique” [“Device for controlling light pulses by a programmable acousto-optic device”] and the publication by D. Kaplan and P. Tournois “Theory and performance of the acousto-optic programmable dispersive filter used for femtosecond laser pulse shaping”, J. Phys. IV, 12 (2002), Pr5-69/75, describing the use of a collinear configuration to achieve spectral filtering programmable in amplitude and laser pulse phase. Tellurium dioxide, or Paratellurite, a highly anisotropic material, is the most used for that application.
Elongating the length of the device to increase the interaction length is technologically limited by the capacities existing to date for crystal growth. Concerning tellurium dioxide, for example, the available devices are limited to a few centimeters long. One solution consists of folding the beams through optical and acoustic reflections on the crystalline faces that maintain the optical and acoustic co-linearity. Nevertheless, the anisotropic nature of the crystal and the very large difference between the wave and beam vector directions will generally have the effect that beams that are collinear before reflection will no longer be collinear after reflection.
The only crystal classes making it possible to meet these requirements are those for which the optical and acoustic axes of symmetry are combined, such as, for example, tetragonal crystal classes 422, 4/mmm and 4/2 m.
The materials combining this condition and suitable performance for such an application are: tellurium dioxide (TeO₂), mercury halides (Hg₂Cl₂, Hg₂Br₂, Hg₂I₂), and KDP; among these materials, only tellurium dioxide (TeO₂), calomel (Hg₂Cl₂) and KDP are open to industrial use today.

The invention therefore concerns a method and a device for acousto-optic filtering with large optic and acoustic interaction length; to that end, it proposes the use of a birefringent acousto-optic crystal whereof the sound wave propagation speed is as low as possible, this acousto-optical crystal comprising, on one of its faces, a piezoelectric transducer intended to generate a transverse sound wave whereof the energy propagates collinearly to the energy of an incident light wave, all along the path of said incident light wave, in the aforementioned birefringent acousto-optic crystal,

knowing that the transverse sound wave and the incident light wave travel a path including multiple reflections on one or the other of the reflective faces of the birefringent acousto-optic crystal perpendicular to the axes of symmetry shared by the acoustic slownesses curve and the curves of the ordinary and extraordinary optical indices of said acousto-optic crystal.

One embodiment of the method according to the invention will be described below, as a non-limiting example, in reference to the appended drawings, in which:

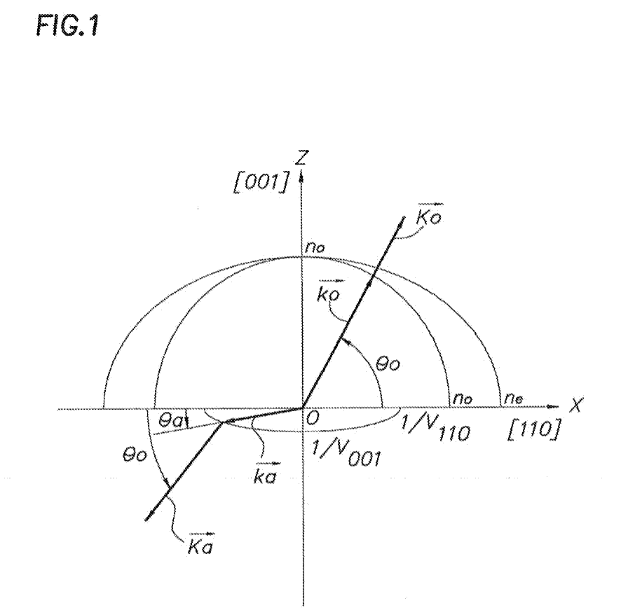

FIG. 1 is a diagrammatic illustration for an anisotropic crystal of the acoustic slownesses curve and the curves of the ordinary and extraordinary optical indices defining the composition of the sound and light wave vectors, characteristic of the acousto-optic interaction;

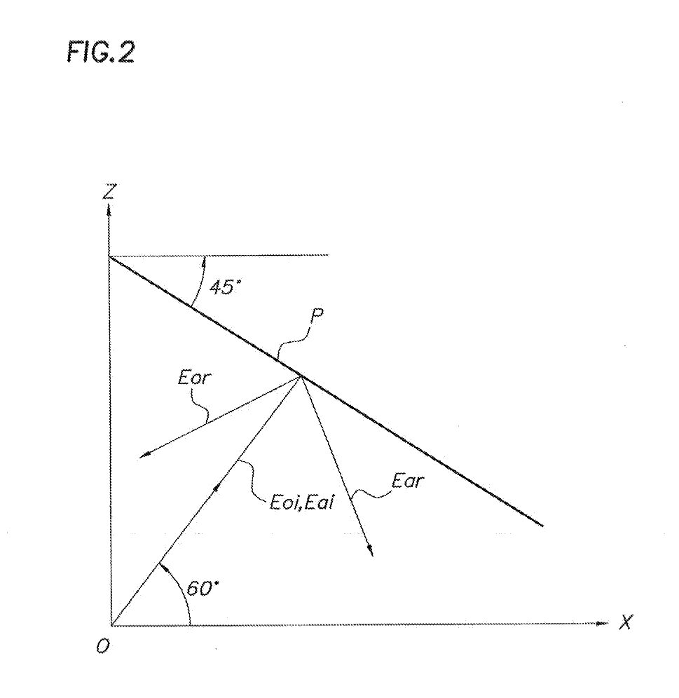

FIG. 2 is a diagrammatic illustration of a first example of reflection of the sound and light beams on an oblique plane, parallel to the axis Oy of the birefringent crystal;

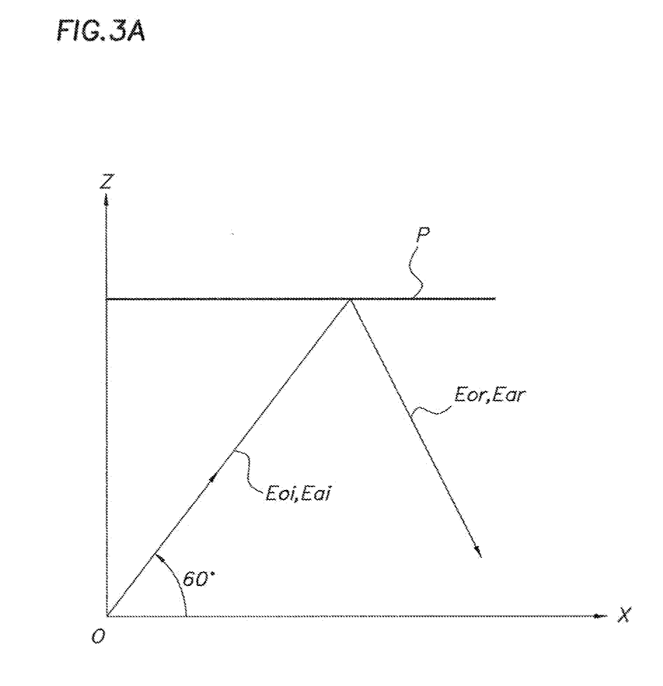

FIG. 3 is a diagrammatic illustration of a second example of reflection of the sound and light beams on a plane parallel to the axes Oy and Ox of the birefringent crystal;

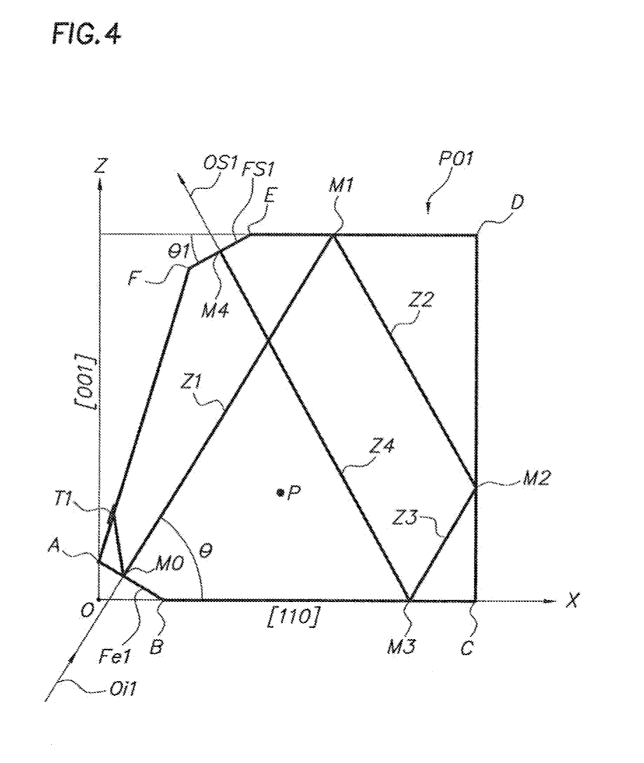

FIG. 4 shows a first example of a diagrammatic illustration of an acousto-optic filter structure with long optical and acoustic interaction length in tellurium dioxide;

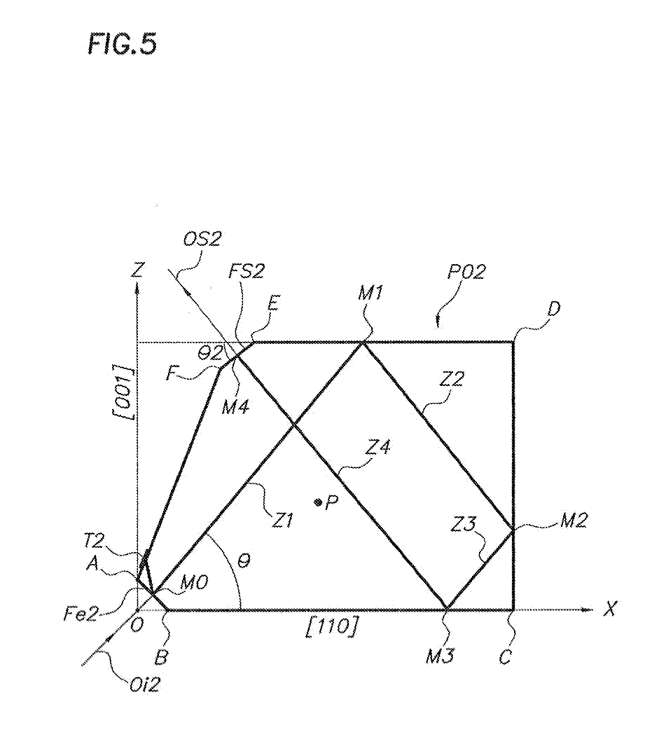

FIG. 5 shows a second example of a diagrammatic illustration of an acousto-optic filter structure with long optical and acoustic interaction length in Calomel, and

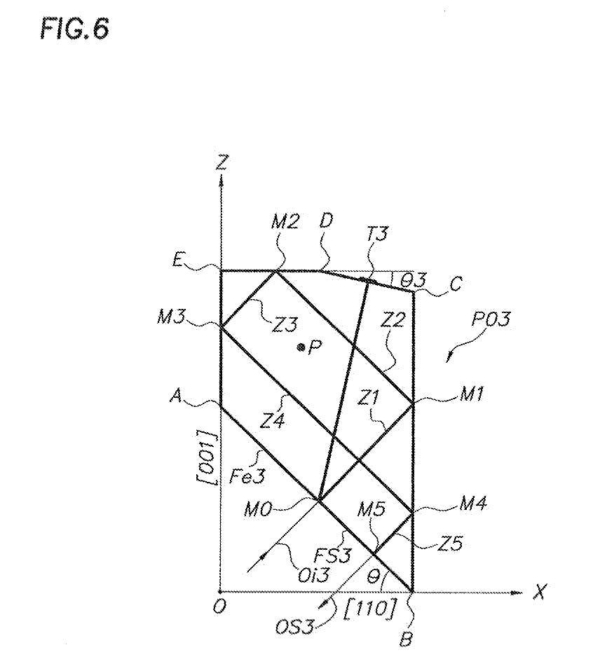

FIG. 6 shows a third example of a diagrammatic illustration of an acousto-optic filter structure with long optical and acoustic interaction length in KDP.

In the example illustrated in FIG. 1, the diagrammatic illustration of the curves of the ordinary and extraordinary optical indices (upper quadrants) and the curve of the acoustic slownesses (lower quadrants) shows, in the orthonormal system defined by the axes Ox and Oz of the birefringent crystal, the sound wave and incident optical wave vectors, kₐ and k₀, respectively; the sound wave vector kₐ forms an angle θₐ with the axis Ox; the incident optic wave vector k₀ forms an angle θ with the axis Ox.
The optic Poynting vector Ko is collinear with the incident optic wave vector kₒ; the acoustic Poynting vector Ka is parallel to the optic vector Ko and therefore forms an angle θ with the axis Ox.
In the example illustrated in FIG. 2, the diagrammatic illustration of a first example of reflection of sound and light wave beams on an oblique plane, parallel to the axis Oy of a birefringent tellurium dioxide (TeO₂) crystal, shows, in the orthonormal system defined by the axes Ox and Oz of the birefringent crystal, the directions of the incident optic and acoustic energies and the directions of the optic and acoustic energies after reflection on an oblique plane P.
In this case, the plane P is parallel to the axis Oy and forms a 45° angle in relation to the axis Ox; the incident optic and acoustic energies Eoi, Eai, form a 60° angle in relation to the axis Ox; the reflection of the optic Eor and acoustic Ear energies does not occur in the same directions.
In the example illustrated in FIG. 3, the diagrammatic illustration of a second example of reflection of the sound and light beams on a plane parallel to the axes Oy and Ox of the birefringent tellurium dioxide (TeO₂) crystal shows, in the orthonormal system defined by the axes Ox and Oz of the birefringent crystal, the directions of the incident optic and acoustic energies and the directions of the optic and acoustic energies after reflection on a plane P.
In this case, the plane P is parallel to the axis Oy and to the axis Ox; the incident optic and acoustic energies Eoi, Eai form a 60° angle in relation to the axis Ox; the reflection of the optic and acoustic energies Eor, Ear occur in the same direction.
In the example illustrated in FIG. 4, an acousto-optic structure with long optical and acoustic interaction length involves an acousto-optic tellurium dioxide (TeO₂) crystal, illustrated diagrammatically by its polygonal section PO₁ by a plane perpendicular to the axis Oy and called propagation plane P.
The orientation of the acousto-optic crystal is defined by its two axes [110] and [001]. The propagation plane P being orthonormal along Ox and Oz, respectively, the axis Ox is parallel to the axis [110], and the axis Oz is parallel to the axis [001].
The light propagation angle θ in relation to the direction Ox is chosen according to a functional criterion. In the example of FIG. 4, it is chosen to maximize the figure of merit of the diffraction efficiency M₂ approximately given by the formula:

M₂=nₒ³nₑ³p²/ρV³,

in which: nₒ, nₑ, p, ρ and V are the ordinary index, extraordinary index, effective elasto-optic coefficient, density of the crystal, and phase speed of the transverse sound waves in the direction θₐ, which corresponds to the propagation direction 8 of the sound energy, respectively.
The phase speed of the transverse sound waves V is given by:

V=[Vₓ² cos² θₐ+V_{z}² sin² θₐ]^{1/2},

with: tan θₐ=(Vₓ/V_{z})²·tan θ,

which is the alignment condition of the sound and acoustic energies, Vₓ being the sound speed along Ox, and V_{z} being the sound speed along Oz.
For TeO₂, Hg₂Cl₂ and KDP crystals, the angles θ are close to 60°, 50° and 45°, respectively.
The crystals in question have a prismatic shape, defined by their straight polygonal section by a plane parallel to the propagation plane P and by the direction shared by their edges perpendicular to the propagation plane. The faces of interest of these crystals are those parallel to the edges and containing a given segment of the straight section. In the following the crystals in question will be designated by their straight section and the crystalline faces by the corresponding straight section segment.
In the first example of FIG. 4, the TeO₂ crystal PO₁, defined by the polygon PO₁ of apices ABCDEF, comprises a first face AB containing the segment AB, A along the Oz axis close to point O and B along the axis Ox close to point O, a second face BC along the axis Ox, then a third face CD perpendicular to the axis Ox, then a fourth face DE perpendicular to the axis Oz, then a fifth face EF forming an angle θ₁ with the normal line at the axis Oz, then a sixth face FA closing the polygonal section PO₁.
The face AB of the crystal PO1 constitutes an inlet face Fe₁ on which is applied, at a point M0, perpendicular to said inlet face Fe₁, an incident light beam Oᵢ₁, polarized perpendicularly to the propagation plane P containing said polygonal section PO₁; the incident light beam Oᵢ₁ as well as the corresponding wave vector kₒ₁ are co-linear with the normal line at the face AB.
A transducer T₁, situated on the face FA, generates a transverse sound beam, the vibrations of which are perpendicular to the propagation plane P; this sound beam arrives at the point M0 of said inlet face Fe₁, then is reflected such that the corresponding acoustic Poynting vector is perpendicular to the aforementioned face AB.
Thus, the reflected sound beam and the aforementioned incident light beam Oᵢ₁ run through a first collinear interaction area Z1 between the point M0 of the face AB and a reflection point M1 on the face DE, then run through a second collinear interaction area Z2 between the point M1 on the face DE and a reflection point M2 on the face CD, then run through a third collinear interaction area Z3 between the point M2 on the face CD and a reflection point M3 on the face BC, then run through a fourth collinear interaction area Z4 between the point M3 on the face BC and a point M4 on the face EF, which constitutes the outlet face Fs₁ of the reflected light beam Oₛ₁.
In each of the interaction areas, the collinear propagation direction is θ or −θ; given the elements previously defined, the incident ordinary light wave vector kₒ₁ forms an angle θ close to 60° with the axis [110].
The interaction length of the light and sound waves was multiplied by a factor close to 3 in relation to the length of the crystal, the height of which is defined by the distance between the aforementioned faces BC and DE.
In the example illustrated in FIG. 5, an acousto-optic filter structure with long optic and acoustic interaction length involves a Calomel (Hg₂Cl₂) acousto-optical crystal illustrated diagrammatically by its polygonal section PO₂, situated in the propagation plane P.
The orientation of the acousto-optic crystal is defined by its two axes [110] and [001]. The propagation plane P being orthonormal along Ox and Oz, respectively, the axis Ox is parallel to the axis [110], and the axis Oz is parallel to the axis [001].
The crystal PO₂ comprises a first face AB, A along the axis Oz close to point O and B along the axis Ox close to point O, a second face BC along the axis Ox, then a third face CD perpendicular to the axis Ox, then a fourth face DE perpendicular to the axis Oz, then a fifth face EF forming an angle θ₂ with the normal line at the axis Oz, then a sixth face FA closing the polygonal section PO₂, with apices ABCDEF.
The face AB of the crystal PO₂ constitutes an inlet face Fe₂ on which is applied, at a point M0, perpendicular to said inlet face Fe₂, an incident light beam Oᵢ₂, polarized perpendicularly to the propagation plane P containing said polygonal section PO₂; the incident light beam Oᵢ₂ as well as the corresponding wave vector k₀₂ are collinear with the normal line at the face AB.
A transducer T₂, situated on the face FA, generates a transverse sound beam, the vibrations of which are perpendicular to the propagation plane P; this sound beam arrives at the point M0 of said inlet face Fe₂, then is reflected such that the corresponding acoustic Poynting vector is perpendicular to the aforementioned face AB.
Thus, the reflected sound beam and the aforementioned incident light beam Oᵢ₂ run through a first collinear interaction area Z1 between the point M0 of the face AB and a reflection point M1 on the face DE, then run through a second collinear interaction area Z2 between the point M1 on the face DE and a reflection point M2 on the face CD, then run through a third collinear interaction area Z3 between the point M2 on the face CD and a reflection point M3 on the face BC, then run through a fourth collinear interaction area Z4 between the point M3 on the face BC and a point M4 on the face EF, which constitutes the outlet face Fs₂ of the reflected light beam Oₛ₂.
In each of the interaction areas, the collinear propagation direction is θ or −θ; given the elements previously defined, the incident ordinary light wave vector kₒ₁ forms an angle θ close to 50° with the axis [110].
The interaction length of the light and sound waves was multiplied by a factor close to 3 in relation to the length of the crystal, the height of which is defined by the distance between the aforementioned faces BC and DE.
In the example illustrated in FIG. 6, an acousto-optic filter structure with long optic and acoustic interaction length involves a KDP acousto-optical crystal illustrated diagrammatically by its polygonal section PO₃, situated in the propagation plane P; the proposed structure is different from those previously described, given the anisotropy and birefringence characteristics of this material.
The orientation of the acousto-optic crystal is defined by its two axes [100] and [001]. The propagation plane P being orthonormal along Ox and Oz, respectively, the axis Ox is parallel to the axis [100], and the axis Oz is parallel to the axis [001].
The crystal PO₃ comprises a first face AB, A along the axis Oz and B along the axis Ox, a second face BC perpendicular to the axis Ox, then a third oblique face CD forming an angle θ₃ with the normal line at the axis Oz, then a fourth face DE perpendicular to the axis Oz, then a fifth face EA closing the polygonal section PO₃, with apices ABCDE.
The face AB of the crystal PO₃ constitutes an inlet face Fe₃ on which is applied, at a point M0, perpendicularly to said inlet face Fe₃, an incident light beam Oᵢ₃, polarized perpendicularly to the propagation plane P containing said polygonal section PO₃; the incident light beam Oᵢ₃ as well as the corresponding wave vector k₀₃ are collinear with the normal line at the face AB.
A transducer T₃, situated on the face CD, generates a transverse sound beam, the vibrations of which are perpendicular to the propagation plane P; this sound beam arrives at the point M0 of said inlet face Fe₃, then is reflected such that the corresponding acoustic Poynting vector is perpendicular to the aforementioned face AB.
Thus, the reflected sound beam and the aforementioned incident light beam Oᵢ₃ run through a first collinear interaction area Z1 between the point M0 of the face AB and a reflection point M1 on the face BC, then run through a second collinear interaction area Z2 between the point M1 on the face BC and a reflection point M2 on the face DE, then run through a third collinear interaction area Z3 between the point M2 on the face DE and a reflection point M3 on the face EA, then run through a fourth collinear interaction area Z4 between the point M3 on the face EA and a point M4 on the face BC, then run through a fifth collinear interaction area Z5 between the point M4 on the face BC and a point M5 on the face AB, which constitutes the outlet face Fs₃ of the reflected light beam Oₛ₂, said outlet face Fs₃ being combined with said inlet face Fe₃.
In each of the interaction areas, the collinear propagation direction is θ or −θ; given the elements previously defined, the incident ordinary light wave vector kₒ₁ forms an angle θ close to 45° with the axis [100].
The interaction length of the light and sound waves was multiplied by a factor close to 5 in relation to the length of the crystal, the height of which is defined by the distance between the aforementioned faces BC and EA.
According to the three examples cited above, the solution consisting of folding the beams through optic and acoustic reflections on the crystalline faces of the birefringent acousto-optic crystal, makes it possible to multiply by a factor close to, or even greater than 3, in relation to the length of said crystal; this method thus allows the significant increase in the optic and acoustic interaction length while respecting the economic constraints related to the realization of such crystals.
Advantageously, the aforementioned reflective faces (AB, BC, CD, DE, EA) may or may not comprise thin dielectric layers or thin metal films.
Advantageously, the aforementioned piezoelectric transducer (T₁, T₂, T₃) intended to generate a transverse sound wave will be a transducer welded on a face (FA, CD) of the birefringent acousto-optic crystal (PO₁, PO₂, PO₃).
A first application of this acousto-optic filter with long acousto-optic interaction length, according to the invention, concerns frequency drift laser spreaders such as those described in the article by D. Strickland and G. Mourou: “Compression of amplified chirped optical pulses,” Optics Communications, 56 (1985), p. 219, which make it possible to generate extremely powerful short light pulses. In this type of laser, a spreader programmable in amplitude and phase with a long deployment time is desirable to offset flaws in the amplitude and the phase of the compressors.
A second application of this acousto-optic filter with long acousto-optic interaction length, according to the invention, concerns spectrum analyzers that use quick and compact acousto-optic tunable filters (AOTF). In this type of filter, a large acousto-optic interaction length makes it possible to noticeably increase the spectral resolution of said filters.
A third application of this acousto-optic filter with long acousto-optic interaction length, according to the invention, concerns the generation of multiple short light pulses, with temporal spacing that can be adjusted over a very long duration, obtained through the simultaneous programming of several acoustic signals in the acousto-optic filter.

1. A method and a device for acousto-optic filtering with large optic and acoustic interaction length comprising a birefringent acousto-optic crystal whereof the sound wave propagation speed is as low as possible, said acousto-optical crystal comprises, on one of its faces, a piezoelectric transducer intended to generate a transverse sound wave whereof the energy propagates collinearly to the energy of an incident light wave, all along the path of said incident light wave, in the aforementioned birefringent acousto-optic crystal,
wherein the transverse sound wave and the incident light wave travel a path including multiple reflections on one or the other of the reflective faces of the birefringent acousto-optic crystal perpendicular to the axes of symmetry shared by the acoustic slownesses curve and the curves of the ordinary and extraordinary optical indices of said acousto-optic crystal.

2. The method according to claim 1,
Wherein the aforementioned acousto-optic crystal is part of the tetragonal crystal classes 422, 4/mmm and 4/2 m.

3. The method according to claim 2,
wherein the aforementioned acousto-optic crystal is tellurium dioxide.

4. The method according to claim 2,
wherein the aforementioned acousto-optic crystal is Calomel.

5. The method according to claim 2,
wherein the aforementioned acousto-optic crystal is KDP.

6. An application of the method according to claim 1 to producing frequency drift laser spreaders.

7. The application of the method according to claim 1 to producing spectrum analyzers using AOTF acousto-optic filters.

8. The application of the method according to claim 1 to producing multiple short light pulses with adjustable temporal spacing.

9. A device for implementing the method according to claim 1 intended for acousto-optic filtering with long optic and acoustic interaction length,
wherein the aforementioned reflective faces comprise thin dielectric layers or thin metal films.

10. The device according to claim 9,
wherein the aforementioned piezoelectric transducer intended to generate a transverse sound wave is a transducer welded on a face of the birefringent acousto-optic crystal.
